(19) United States
(12) Patent Application Publication
(10) Pub. No.: US 2022/0237673 A1
(43) Pub. Date: Jul. 28, 2022

(54) SYSTEMS AND METHODS FOR SECURING AND GENERATING REAL-TIME PRODUCT DATA STREAMS TO ENABLE LOW-LATENCY TRANSACTIONS

(71) Applicant: Shawn Muthraja, Bellerose, NY (US)

(72) Inventor: Shawn Muthraja, Bellerose, NY (US)

(21) Appl. No.: 17/617,158

(22) PCT Filed: Jun. 5, 2020
(86) PCT No.: PCT/US2020/036419

§ 371 Date: Dec. 7, 2021

Related U.S. Application Data
(60) Provisional application No. 62/858,601, filed on Jun. 7, 2019.

(51) Int. Cl. G06Q 30/06; G06Q 30/08; G06Q 20/02; G06Q 20/40; G06Q 20/38; G06Q 10/08

(52) U.S. Cl. CPC G06Q 30/0613; G06Q 30/08; G06Q 10/087; G06Q 20/407; G06Q 20/382; G06Q 20/02

(57) ABSTRACT

The present disclosure includes systems and methods for generating real-time high-frequency product data stream to enable low-latency transactions based on inventory data available from one or more third-party seller platform servers executing a platform that lists a plurality of products. The systems and methods of the present disclosure provide sanitized real-time high-frequency product data stream that is actionable and can be shared with third-party market participants. The system and methods can secure the system that facilitates low-latency transactions using firewalls and access control rules that compartmentalizes access to information using multiple data layers for the sub-systems.

### CROSS REFERENCE TO RELATED APPLICATIONS

The present application claims the benefit of U.S. Provisional Patent Application No. 62/858,601, filed on Jun. 7, 2019, which is incorporated herein by reference in its entirety.

### BACKGROUND OF THE DISCLOSURE

Systems that track inventory data and sales data are designed to provide updates on changes to the inventory sporadically. For example, the inventory data provided by reseller computing system is generally not reliable. The reseller computing system generally does not allow purchase of the last remaining item on the shelf online because of the reliability issues in the inventory data due to a difference between the actual inventory position as a result of delays in updates to the inventory data. Also, the reseller computing systems that provide inventory data are not designed for real-time access and repeated polling of inventory data in quick succession. The delay between consecutive access to inventory data results in slippage between the inventory data and the actual inventory when an item is sold, but is not reflected in the inventory data. Therefore, the inventory data is not actionable in real-time for low-latency transactions.

Additionally, third-party seller platform servers executing platforms that offer a listing of products do not provide inventory data that is sanitized to remove personally identifiable information of the customers, and metrics of the one or more reseller or provide inventory data in a form that can be shared with third parties. Sharing such inventory data can create security risks that affect the one or more third-party seller platform servers, the seller and the customer.

### SUMMARY OF THE DISCLOSURE

Embodiments of the present disclosure include systems and methods for generating real-time high-frequency product data streams to enable low-latency transactions based on inventory data available from one or more third-party seller platform servers executing a platform that lists a plurality of products. The systems and methods of the present disclosure provide sanitized real-time high-frequency product data streams that are actionable and can be shared with third-party market participants. In exemplary embodiments, the systems and methods can generate real-time high-frequency product data stream based on a low-latency scalable subsystem that normalizes and sanitizes sensitive information associated with a market participant on the one or more third-party seller platform servers. The system and methods converts the inventory data retrieved available on the reseller computing system into high-frequency product data streams to enable low-latency transactions. In exemplary embodiments, the system and methods can generate real-time high-frequency product data streams from traditional inventory data retrieved from the reseller computing system, where the traditional inventory data is subject to polling rate limitations by storing retrieved information in an inventory database and polling the one or more third-party seller platform servers at a rate below a throttling threshold for updates. Examples of updates that the systems and methods poll can includes new sale of item information or updates to the inventory of items on the reseller computing system. In exemplary embodiments, the system includes redundancy of the sub-systems to increase the reliability and availability of the system.

In accordance with embodiments of the system and methods disclosed herein can validate a real-time inventory across one or more third-party seller platform servers executing a platform listing items for sale, determine the future value of each item in the product data stream, generate a current value of each item in the inventory, auction each item using an exchange mechanism to generate a transaction to capture the future value of the item for one of the market participants and fund the current value of the item for one of the market participants, securitize the revenue stream from each item in the transaction, manage the revenue stream from a future sale of each item in the transaction, without registering a sale on the one or more third-party seller platform servers and settle the proceeds of a future sale of the item on the one or more third-party seller platform servers between the market participants by automatically transferring proceeds of the sale of the securitized item to the customer between the market participants of the transaction.

In exemplary embodiments, the system includes a plurality of scalable sub-systems such an inventory service system, a trading backend and a transaction engine that secures real-time low-latency high-frequency product data stream that is actionable and normalized to remove sensitive information to enable sharing of the product data stream with third-party market participants without risk. The system provides a low-latency network architecture for high-frequency exchange of product data stream by normalizing the inventory data to homogenize the inventory data for similar items on the one or more third-party seller platform servers.

In exemplary embodiments, the system and methods can secure the system that facilitates low-latency transactions using firewalls and access control rules that compartmentalizes access to information using multiple data layers for the sub-systems. The system can compartmentalize and remove sensitive information using sub-systems, multiple firewalls, when exchanging information in real-time between the inventory service system, trading backend and the transaction engine. The system secures transactions between sub-systems that deal with sensitive information from different market participant systems via a series of data streams such as a product data stream, a trading stream and a financial stream to enable low-latency transactions. In exemplary embodiments, the system can secure the real-time data using a plurality of firewalls that provide various access points such as developer application programming interfaces, a front end access for participant system, and administrator access to the system from a network such as the internet.

In exemplary embodiments, the system and methods can validate a real-time inventory associated with a first market participant across a plurality of third-party selling platform servers that list a plurality of products using an inventory service system, store the real-time inventory associated with the first market participant in a master inventory database, normalize the real-time inventory across the plurality of third-party selling platform servers using the inventory service system, transmit the normalized real-time inventory via a high-frequency product data stream based on inventory data stored in the master inventory database, determine a value associated each item in the inventory using a trading backend, determine a current value associated with each of the plurality of items and a projected future value associated with each of the plurality of items using the trading backend, generate a list including each of the plurality of items in a real-time exchange accessible to a second market participant using the trading backend, determine whether inputs (e.g., transaction criteria) from the first and second market participants match for each of the plurality of items, in response to determining that the inputs from the first and second market participants match for at least one of the plurality of items, establish a transaction between the first market participant and the second market participant for at least one of the plurality of items without physical movement of the items or updating the plurality of third-party selling platform servers, pending sale to a customer, authorize release of funds from an account associated with the second market participant to the first market participant, capture a sale of the at least one of the plurality of items on the plurality of third-party selling platform servers when each item is sold via an application programming interface, and transfer funds to an account associated with the second market participant in response to capturing the sale.

In exemplary embodiments, the system and methods can poll the plurality of third-party selling platform servers at a polling rate less than a throttling threshold using the inventory service system, parse a sales report received from the plurality of third-party selling platform servers to determine a change in the inventory data associated with the first market participant, sale of items in the inventory or both using the inventory service system, and generate the high-frequency product data stream based on inventory data stored in the master inventory database and the parsed sales report.

In exemplary embodiments, the system and methods can package multiple items into an item listing before creating a list including each of the plurality of items.

In exemplary embodiments, the system and methods can receive offers from the first market participant to list each item using the trading backend.

In exemplary embodiments, the system and methods can receive offers to modify each listed item using the trading backend.

In exemplary embodiments, the system and methods can track an account on the plurality of third-party selling platform servers that is associated with the first market participant to determine when the at least one of the plurality of items is sold using a transaction engine, poll the plurality of third-party selling platform servers to receive sales data using the transaction engine, validate the sale of the at least one of the plurality of items based on a sales report received from the plurality of third-party selling platform servers using the transaction engine, transfer funds from an account associated with the first market participant to an escrow account using the transaction engine, and transfer funds from the escrow account to the account associated with the second market participant using the transaction engine.

In exemplary embodiments, the system and methods can validate the eligibility of the second market participant based on an availability of funds before allowing the second market participant to use the trading backend.

In exemplary embodiments, the system and methods can determine a return of an item for refund on at least one of the plurality of third-party selling platform servers, determine whether the funds in the account of the first market participant are insufficient to cover the refund, and in response to a determination that the funds are insufficient generate a credit request to address the insufficiency of funds in the account of the first market participant.

In exemplary embodiments, the system and methods can determine a return of an item on at least one of the plurality of third-party selling platform servers, using a transaction engine, and adjust the real-time listing of products to reflect a change in inventory of the item using the transaction engine.

In exemplary embodiments, the system and methods can store an immutable ledger of the transactions after matching the inputs of the first and second market participants related to the at least one of the plurality of items.

Any combination or permutation of embodiments is envisioned. Additional advantageous features, functions and applications of the disclosed assemblies, systems and methods of the present disclosure will be apparent from the description which follows, particularly when read in conjunction with the appended figures. The references, publications and patents listed in this disclosure are hereby incorporated by reference in their entireties.

### BRIEF DESCRIPTION OF THE DRAWINGS

Features and aspects of embodiments are described below with reference to the accompanying drawings, in which elements are not necessarily depicted to scale.

Exemplary embodiments of the present disclosure are further described with reference to the appended figures. It is to be noted that the various features, steps and combinations of features/steps described below and illustrated in the figures can be arranged and organized differently to result in embodiments which are still within the scope of the present disclosure. To assist those of ordinary skill in the art in making and using the disclosed assemblies, systems and methods, reference is made to the appended figures, wherein:

FIG. 1 is an illustration of an example system for securing and generating real-time high-frequency product data stream to enable low-latency transactions according to embodiments of the present disclosure;

FIG. 2 illustrates an exemplary inventory engine for generating real-time high-frequency product data streams from traditional inventory data according to embodiments of the present disclosure;

FIG. 3 illustrates an exemplary flow chart of inventory management according to embodiments of the present disclosure;

FIG. 4 illustrates an exemplary flow chart of sales tracking according to embodiments of the present disclosure;

FIG. 5 illustrates an exemplary trading backend according to embodiments of the present disclosure;

FIG. 6 illustrates an exemplary front end generated by the system according to embodiments of the present disclosure;

FIG. 7 illustrates an exemplary trading lifecycle workflow for the system according to embodiments of the present disclosure;

FIG. 8 illustrates an exemplary transaction engine according to embodiments of the present disclosure;

FIG. 9 illustrates an exemplary transaction ledger stored in the data layer according to embodiments of the present disclosure;

FIG. 10 illustrates an exemplary front end delivery system according to embodiments of the present disclosure;

FIG. 11 illustrates an exemplary streaming server to enable high-frequency trading according to embodiments of the present disclosure;

FIG. 12 illustrates an exemplary authentication service according to embodiments of the present disclosure;

FIG. 13 illustrates an exemplary on-boarding service according to the embodiments of present disclosure;

FIG. 14 illustrates an exemplary Know Your Customer (KYC) process used by the system according to embodiments of the present disclosure;

FIG. 15 illustrates an exemplary back-office administration application according to embodiments of the present disclosure;

FIGS. 16A and 16B are an exemplary flow chart of securing and generating high-frequency real-time inventory data according to embodiments of the present disclosure; and

FIG. 17 illustrates an exemplary block diagram of an exemplary computing device for implementing exemplary embodiments of the present disclosure.

### DETAILED DESCRIPTION OF THE DISCLOSURE

The exemplary embodiments disclosed herein are illustrative of methods and related systems for securing and generating real-time high-frequency product data streams according to the present disclosure. The system can generate real-time low-latency high-frequency product data streams based on inventory data stored on one or more third-party seller platform servers executing a platform listing a plurality of products based on a low-latency scalable subsystem. The low-latency scalable sub-systems normalize and sanitize the sensitive information and converts the inventory data into product data streams that can be used for low-latency transactions. The system can secure an exchange based on a plurality of scalable sub-systems such as an inventory service system, a trading backend and a transaction engine that provide a low-latency network architecture for high-frequency exchange of data between the sub-systems via data streams. The system can secure the data transfer between systems associated with the various systems associated market participant systems, developers' interfaces and administrative accesses systems based on multiple firewalls that compartmentalizes data between the sub-systems.

Details disclosed herein with reference to exemplary systems/assemblies and associated processes/techniques of assembly and use are not to be interpreted as limiting, but merely as the basis for teaching one skilled in the art how to make and use the advantageous assemblies, systems and methods of the present disclosure.

Generating real-time high-frequency product data streams based on inventory data available on one or more third-party seller platform servers listing a plurality of products is a method of producing an product data stream that normalizes the list of items for sale on a platform executing on one or more third-party seller platform servers while removing the sensitive information associated with the market participants and providing real-time actionable data from sources that are not designed to support high-frequency real-time data streams. The product data stream allows market participants to trade based on actual inventory levels of products listed for sale on the platforms executing on one or more third-party seller platform servers.

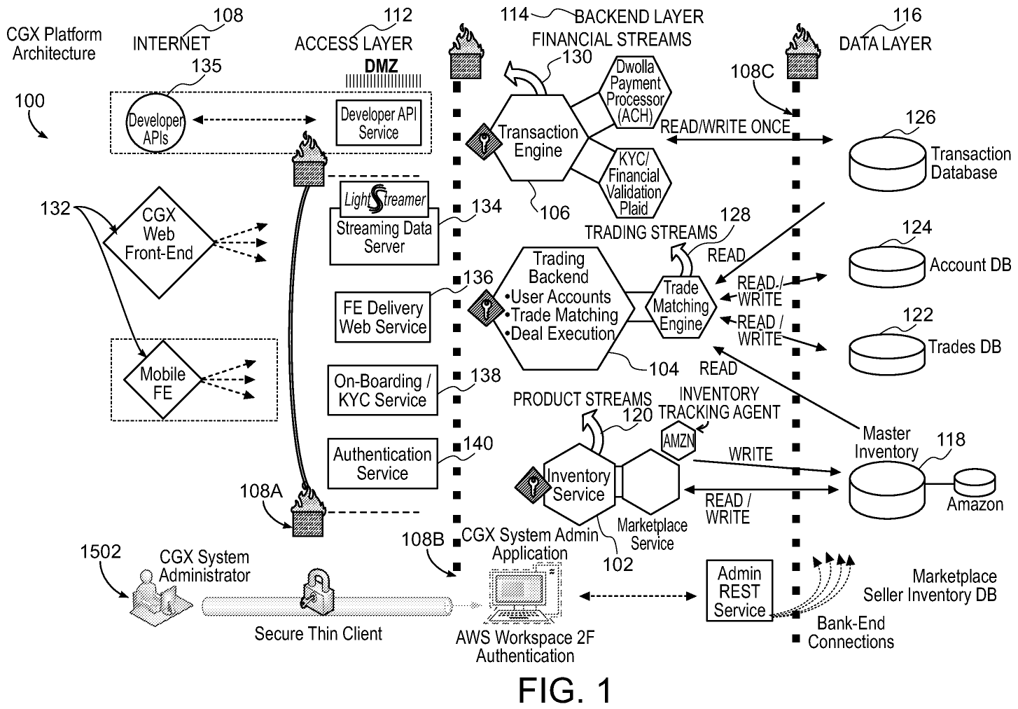

With reference to FIG. 1, an illustration of the system for securing and generating real-time product data streams to enable low-latency transactions according to the present disclosure is provided. The system 100 includes individually scalable sub-systems such an inventory service system 102, a trading backend 104, and a transaction engine 106 that are separated from each other and from a network 110. The system 100 can allow market participant systems access via the network 110 through a plurality of firewalls. The market participant systems can include systems associated with a first market participant such as the seller-entity, and systems associated with a second market participant such as the investor-entity. In an exemplary embodiment, the market participant systems can include other market participants such as the systems associated with a market-maker entity.

The system 100 can separate the individually scalable sub-systems from network 110 via firewalls that restrict access between different security layers such as an access layer 112, backend layer 114, and a data layer 116 to secure the exchange system. The system 100 can include an access layer firewall 108a between the network 110 and the sub-systems of the access layer 112, a backend firewall 108b between the access layer 112 and the backend layer 114 and a data layer firewall 108c between the backend layer 114 and the data layer 116. In exemplary embodiments, the backend layer 114 can include the inventory service system 102, the trading backend 104 and the transaction engine 106. The data layer 116 can include databases associated with the sub-systems in the backend layer 114.

In an exemplary embodiment, the system 100 can secure the information in sub-systems by initializing instances of the sub-systems to secure information in the instances. For example, the system 100 can generate an instance of the inventory service system 102 for each first market participant to secure information relating to the first market participant while generating real-time high-frequency product data stream for the first market participant within the instance. The instance of the inventory service system 102 can login to the one or more third-party seller platform servers associated with the first market participant to process information about the inventory of items, sales data for the first market participant on the reseller computing system, while protecting the sensitive information associated with the first market participant on the one or more platforms. In an exemplary embodiment, the inventory service system 102 does not allow sensitive information such as personally identifiable information, social security numbers and the like to be sent outside to other sub-systems even within the same layer.

The inventory service system 102 generates real-time high-frequency product data stream based on inventory data stored on one or more third-party seller platform servers listing items based on a low-latency scalable subsystem. The low-latency scalable sub-systems normalize the inventory data across the one or more third-party seller platform servers and sanitizes sensitive information and coverts the inventory data into a product data stream 120. The inventory service system 102 can poll the plurality of reseller computing system to determine the available inventory of items, and the sales information for each of the items. In an exemplary embodiment, the inventory service system 102 can determine the inventory of items in one or more fulfillment centers, that caters to fulling orders placed on one or more third-party seller platform servers to update the product data stream 120.

The inventory service system 102 can normalize the inventory data from multiple reseller computing systems, fulfilment centers or both in real-time to generate the product data stream 120. For example, the inventory service system 102 can determine the inventory of an item stored in fulfillment centers associated with different reseller computing systems offering the item for sale, based on the inventory data from the different reseller computing systems and the sales data indicating the current orders that are in the process of being fulfilled from the inventory. In another example, the inventory service system 102 can determine the inventory of an item listed for sale on multiple platforms that are serviced from a fulfilment center based on the sales information from the one or more third-party seller platform servers and the inventory data from the fulfilment center. The inventory service system 102 can use information such as SKU's, ISBN numbers, UPCs, the product description, the rating system and the like to normalize the inventory data for an item. For example, the inventory service system 102 can determine products that are comparable between one or more one or more third-party seller platform servers such as eBay and Amazon based on the SKU number and the condition of the item. In embodiments, the inventory service system 102 can package multiple items into an item listing before creating a list including each of the plurality of items.

The inventory service system 102 can remove sensitive information such a personally identifiable information, and the like before generating the product data stream 120. The product data stream 120 can include a listing of items that are available for sale from the first market participant, the number of items available, the condition of the item and the like.

In an exemplary embodiment, the inventory service system 102 stores the normalized inventory data in a master inventory 118. The inventory service system 102 can then generate the product data stream 120 by polling the one or more platforms for sales data from the one or more platforms and the cached inventory data in the master inventory 118. This inventory service system 102 can then provide the product data stream 120 from the one or more platforms that have polling frequency limits by polling for updated sales data below the throttling threshold of the one or more platforms. The inventory service system 102 can retrieve minimal information from the one or more platforms and combine the retrieved information with information from the master inventory 118 to reduce the latency of the product data stream 120 to enable low-latency transactions.

The trading backend 104 can simulate a financial exchange for matching inputs (e.g., transaction criteria, bids and offers) for the items (such as consumer goods) between the market participants. The trading backend 104 can authenticate the market participants and allow execution of trades between the market participants. In an exemplary embodiment, the trading backend 104 can authenticate the identity of the market participants such as first market participant (e.g., seller-entity), the second market participant (e.g., investor-entity) and the market-maker entity using an authentication system. Examples of authentications systems can include a user name and password, two-factor authentication and the like. The trading backend 104 can receive the product data stream 120 from the inventory service system 102. The trading backend 104 can use the product data stream 120 to provide a real-time listing of like items and the price points of the items similar to an equities exchange, futures exchanges, forex exchange and the like to the market participants. The trading backend 104 can update items on the exchange when the items are sold to customers on the one or more third-party seller platform servers in real-time to provide actionable data to the market participants. In an exemplary embodiment, the trading backend 104 can access information from the master inventory 118 to access information on items to update the listing of like items available for trading in response to an updated product data stream 120. In exemplary embodiments, the trading backend 104 can have restricted read-only access to the master inventory 118 to secure the data in the master inventory 118 from accidental updates, intrusions or both.

The trading backend 104 can match the inputs from the market participants (e.g., criteria, bids and offers) to finalize a transaction between the market participants and store the concluded transactions in the trades database 122. The trading backend 104 can use the account database 124 to determine the funds available for the second market participant to qualify the second market participant for a trade. For example, the trading backend 104 can for example, match trades between the first market participant and the second market participant for new iphone 7's at a specific price based on the bids and the asks for the iphone 7's on the simulated exchange. The trading backend 104 can then qualify the second market participant for the trade based on the information from the accounts database 124 and store the information about the trades in the trades database 122.

The trading backend 104 can generate a trading stream 128 that includes information about the matched trades and updates to the real-time simulated information available to the market participants to enable low-latency transactions. The trading stream 128 can include information about the item, the market participants involved in a transaction, the price of the transaction and the like. In an exemplary embodiment, the trading backend 104 has read-only access to a transaction database 126 to retrieve information about prior transactions of the market participants. The trading backend 104 can use information from the transaction database 126 such as funds available from the sale of an item on one or more third-party seller platform servers to a customer to determine the eligibility or availability of funds for further transactions. In an exemplary embodiment, the trading backend 104 can use information from the transaction database 126 to determine return of an item and to adjust the real-time listing of items to reflect the change in inventory of the item. For example, the return can be a replacement which results in a decrease in the quantity of items available for sale or the return can be a no-fault return which results in an increase in the quantity of items available and the like.

The transaction engine 106 can receive the trading stream 128 from the trading backend 104 to process information about the trades and handle the securitization of the item sold and transfer of payment between the market participants to monetize the future revenue stream for the second market participant. The transaction engine 106 can use the matched trades information from the trading stream 128 to determine the price of the items and process the financial transaction between the bank, the second market participant, the first market participant or a combination thereof. In an exemplary embodiment, the transaction engine 106 can generate a financial stream 130 to process the financial transactions with a bank. For example, the transaction engine 106 can transfer funds from the second market participant to the first market participant based on the matched trade from an escrow account on the system 100 to the account of the first market participant for a transaction on the exchange.

The transaction engine 106 can also store the transaction in the transactions database 126. The transactions database 126 can be an immutable record of transactions. In exemplary embodiments, the transactions database 126 can be a block chain, a double entry ledger or the like.

The transactions engine 106 can securitize the inventory on the one or more third-party seller platform servers executing a platform listing the items that are part of prior transactions to monetize the sale of the item and fulfilment of items to customers on the one or more platforms on behalf of the second market participant. For example, the transactions engine 106 can determine when the product is sold and move the funds from the one or more third-party seller platform servers (e.g., Amazon first market participant account) to the account of the second market participant for items that were part of prior transactions. The transactions engine 106 can similarly debit money from the first market participant for defective returns and the like. The transactions engine 106 can also transfer payments that were not part of a prior transaction to the first market participant when items on the inventory list is not part of a transaction between the first market participant and the second market participant and the item is sold to a customer.

The system 100 can include a front end 132 to allow the market participants access to the system 100 via a network connection such as the internet 108. The front end 13 can be a web based front end, a dedicated application running on a computing device or a mobile device associated with the market participant. The system 100 can provide application programming interface 135 to developers to interact with the system 100 without using the front end 132. The system 100 can allow the market participants to use computing devices to automate their trading via the application programming interface 135.

The access layer 112 can include a streaming data server 134, front end delivery service 136, on-boarding service 138 and an authentication service 140. The streaming data server 134 can provide market information to the participants via the front end 132 based on the product data stream 120. The streaming data server 134 and the front end delivery service 136 can be located behind the access layer firewall 108a and has restricted access to information from the backend layer 114. Similarly, the on-boarding service 138 and the authentication service 140 has limited access to information about the market participants from the backend layer 114 and the data layer 116.

The system 100 can also include a dedicated access control system to allow administrators access to the backend layer 114 that is separate from the access provided to market participants to secure the system by compartmentalizing the system. For example, the system 100 can include a server that can be accessed through a secure thin client or a virtual private network to access the backend layer and further admin rest system to access information stored in the data layer 116. The system 100 can prevent direct access to information in the backend layer 114 from unknown applications and can prevent unauthorized access to information in the data layer 116 using firewalls and intrusion detection systems.

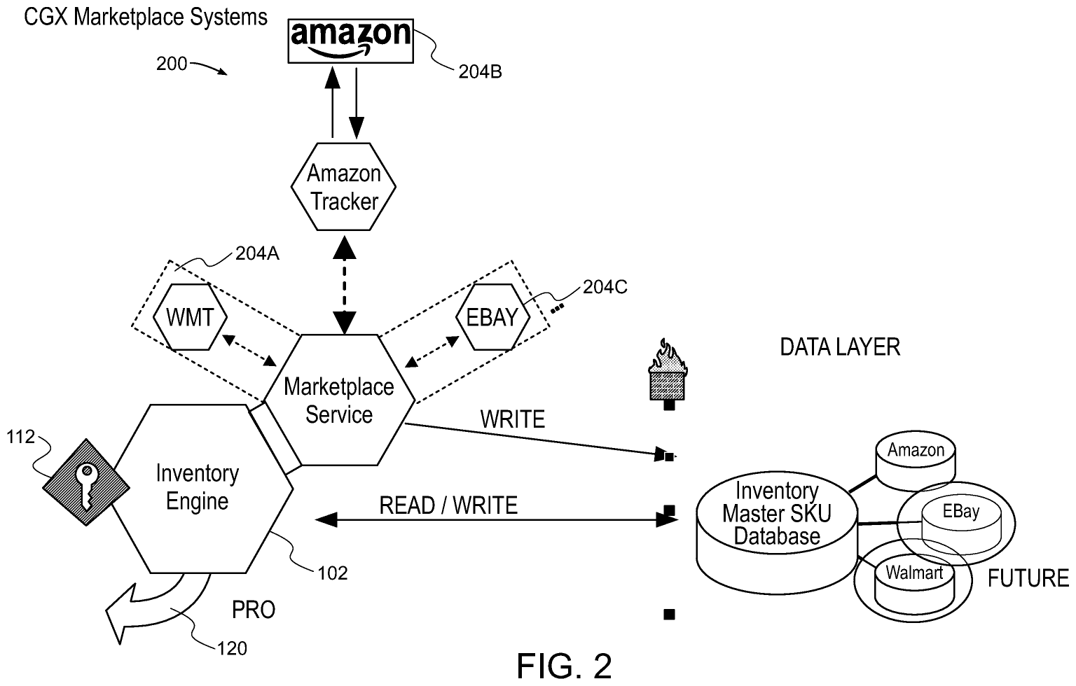

The system 100 can determine the inventory data, sales data from one or more platforms using the inventory service system 102 shown in FIG. 2. The inventory service system 102 can include a market place service 202 that interfaces with the one or more third-party seller platform servers 204A, 204B, 204C (e.g., Walmart, Ebay, Amazon) to retrieve inventory data, sales data or both. The inventory service system 102 can receive information via the access layer 112 from market participants. For example, the inventory service system 102 can receive information such as such as login information for the one or more services for the first market participant, the second market participant and the like. The inventory service system 102 can receive state-less information related to trading and transactions via REST calls over the local network. The system 100 can use this architecture to scale the processing capabilities by using multiple instances of the inventory service system 102 or by increasing the processing power available to handle multiple requests per unit time. In exemplary embodiments, the inventory service system 102 can be scaled to handle anywhere between one request to hundreds of thousands of requests per second.

The inventory service system 102 uses one or more trackers (e.g., tracker 206) that poll the one or more third-party seller platform servers 204A, 204B, 204C to retrieve inventory data to generate the product data stream 120. The tracker 206 can poll the third-party seller platform server 204C to obtain the information such as the inventory of items, quantity of items sold to determine the change in inventory of items associated with the first market participant on the third-party seller platform servers 204C. The tracker 206 can polls information at a rate that is less than the maximum polling rate or less than the throttling threshold for the one or more third-party seller platform servers 204A, 204B, 204C to mitigate throttling of the marketplace API.

The inventory service system 102 can enable the first market participant to download their own SKUs to the system 100 to customize their interaction with the system 100 for trading. The inventory service system 102 can use these SKU's of the first market participant to configure offers in the trading backend 104. In an exemplary embodiment, the inventory service system 100 can assign a universal SKU for each product such as the ISBN or ISIN number to match products from different first market participants and/or different marketplaces.

The inventory service system 102 can normalize the inventory of items across various reseller computing systems. For example, a first market participant can use one fulfillment service to fulfill orders from multiple online platforms such as Amazon, Walmart, Target and the like. The inventory service system 102 can poll the sales information from each of the online platforms in real-time to obtain the sales during a period of time and the inventory of the products available in one or more fulfilment centers. In examples, the inventory service system 102 can poll a fulfilment service associated with a reseller computing system such as Amazon to determine the currently available inventory based on the products that are sold on multiple reseller computing systems executing platforms that offer the items for sale. The inventory service system 102 can also poll the inventory data from multiple fulfilment centers that store items in the inventory to generate the product data stream 120.

In an exemplary embodiment, the inventory service system 102 can use artificial intelligence algorithms to determine the items that are comparable across the one or more third-party seller platform servers. For example, an online one or more third-party seller platform servers can allow sale of items such as empty boxes of an item (e.g., iPhone box), which could be interpreted as an iPhone. The inventory service system 102 can use machine learning algorithms to determine comparable products based on historical prices for items, the current price of items on one or more third-party seller platform servers and discounts associated with the item on other platforms and the condition of the item. In an example, the inventory service system 102 can use a convolutional neural network to analyze the images associated with the item to differentiate between an empty box and a product for sale.

The inventory service system 102 can generate a normalized inventory data and store the inventory data in the master inventory 118 that is secured behind the data layer firewall 108c. The inventory service system 102 can generate the product data stream 120 as describe above with reference to FIG. 1. The inventory service system 102 can interface with the front end 132 via the inventory streaming adaptor in real-time to update the normalized inventory data for the items in real-time based on the product data stream 120.

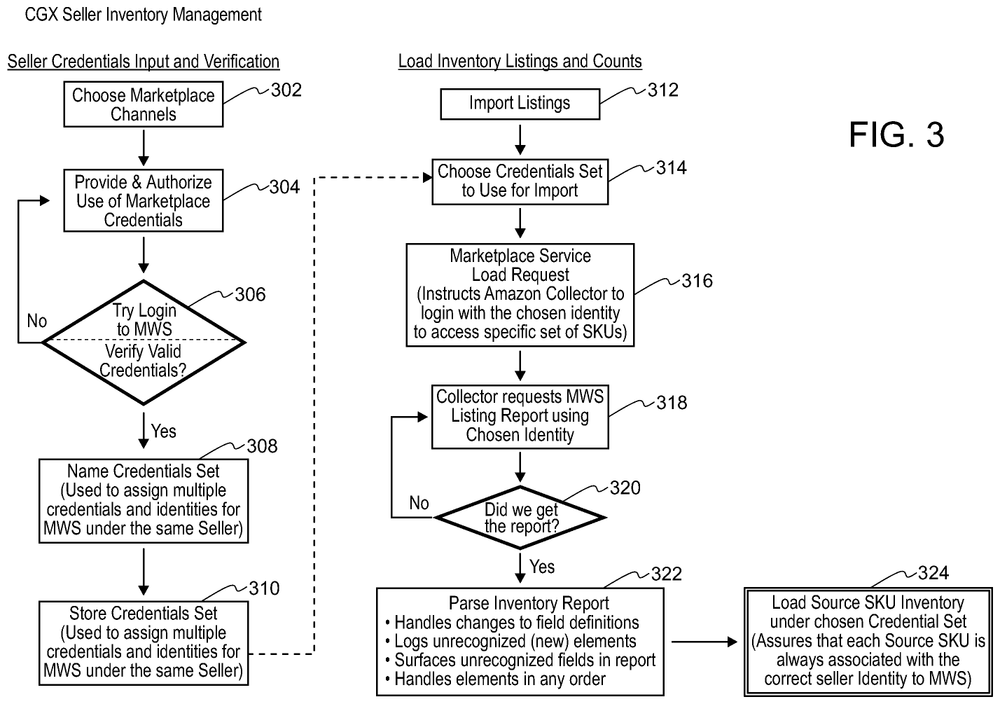

With reference to FIG. 3, the system 100 can use the work flow illustrated in a flow chart to manage the inventory for the first market participant. The system 100 can receive information from the computing device of the first market participant to connect and load information about inventory in the one or more third-party seller platform servers 204A, 204B, 204C., one or more fulfilment centers or both. The system 100 can receive information from the front end 132 to secure access to the inventory data on the one or more third-party seller platform servers 204A, 204B, 204C. In exemplary embodiments, the system 100 can import the inventory during the sign-up process or after sign-up via a form available post sign-up.

The operations 302-310 describe receipt of the credentials from the first market participant and operations 312 to 324 describe the process of importing inventory data from the one or more third-party seller platform servers 204A, 204B, 204C. In operation 302, the inventory service system 102 receives information about the reseller computing system such as the identity of the reseller computing system. For example, the inventory service system 102 can receive a selection from the market participant indicting the reseller computing system is an Amazon reseller computing system. In operation 304, the inventory service system 102 receives authorization to use the credentials associated with market participant and authorization to retrieve information from the reseller computing system. In operation 306, the inventory service system 102 verifies whether the credentials are valid. In operation 308, the system 100 allows the market participant to assign multiple credential sets for the same market participant for the one or more third-party seller platform servers 204A, 204B, 204C. In operation 310, the system 100 stores the credentials of the market participant in the data layer 116.

In operation 312, the inventory service system 102 allows the user to import listings or inventory data from the one or more third-party seller platform servers 204A, 204B, 204C. In an exemplary embodiment, the inventory service system 102 can allow the import of inventory data from the one or more third-party seller platform servers 204A, 204B, 204C during sign-up or at a subsequent login. The inventory service system 102 can also access the inventory data post sign-up using this work flow to update the real-time inventory data.

In operation 314, the inventory service system 102 can choose the credential set to use for importing based on the stored credentials from the data layer 116. In operation 316, the inventory service system 102 can use the tracker 206 to identify and access the SKU's of the first market participant from the one or more third-party seller platform servers. In exemplary embodiments, the inventory service system 102 can access a limited set of SKU's associated with the first market participant. In operation 318, the inventory service system 102 can request a listing report from the one or more third-party seller platform servers 204A, 204B, 204C. In operation 320, the system 100 can determine whether the listing report was received and validate the report. In operation 322, the inventory service system 102 can parse the report to normalize the inventory data. For example, the system 100 can load changes to field definitions, log unrecognized new elements, surface unrecognized fields in the report and the like. The inventory service system 102 can also handle the elements in the report in any order in which the elements are presented. In operation 324, the inventory service system 102 can load the SKU inventory under the chosen credential set to ensure that each source SKU is associated with the right credential set.

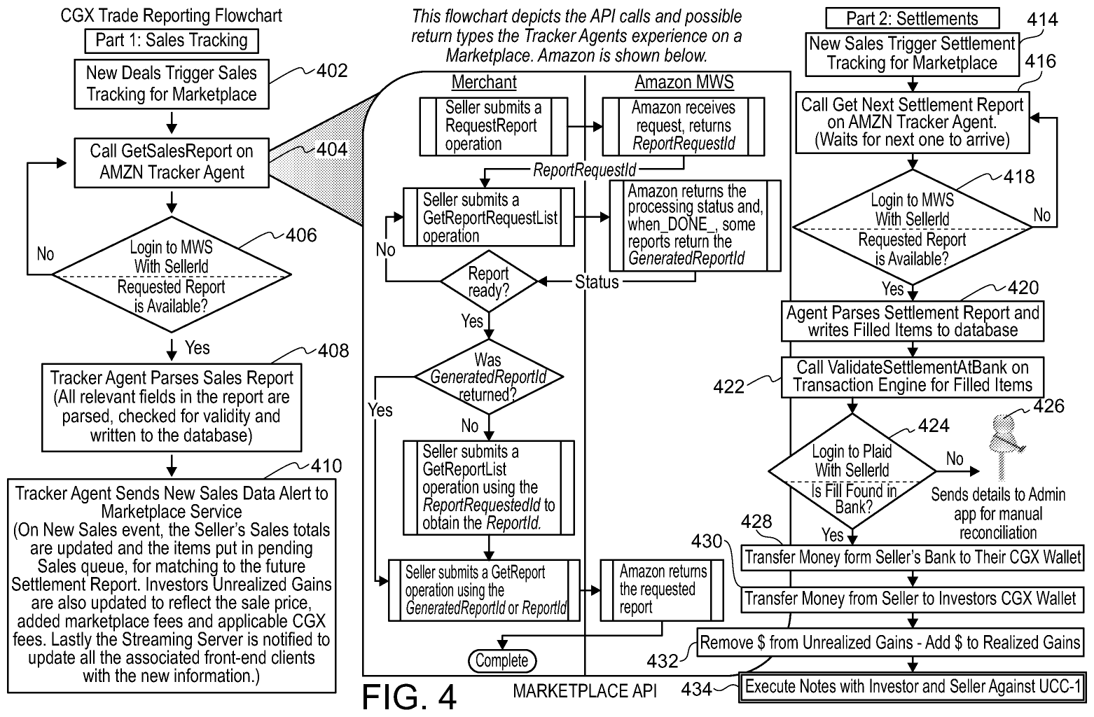

With reference to FIG. 4 an exemplary flow chart of sales tracking for a market participant is illustrated. The operations 402-410 describe sales tracking of items in the inventory and operations 414 to 434 describe the process of settlements of securitized items when the securitized item is sold to a customer on the one or more third-party seller platform servers 204A, 204B, 204C. In operation 402, the transaction engine 106 receives information about new deals on the one or more third-party seller platform servers. In operation 404, the transaction engine 106 polls the third-party seller platform servers 204A, 204B, 204C via the tracker 206 to receive sales report. In operation 406 the transaction engine 106 verifies whether the report was retrieved and has data. In operation 408, the transaction engine 106 parses the sales report to identify the relevant fields of the report and validates the deal and writes the transaction to the transaction database 126. In operation 410, the transaction engine 106 sends the new sales data alert to the market place service. The system 100 based on the new sales event, updates the sales totals for the first market participant, places the item in the sales pending queue for matching the item to the future sales report. The system 100 also update the second market participant unrealized gains to reflect the sale price, added marketplace fees and the system 100 fees. The system 100 also notifies the streaming data server 134 via one of the data streams to update information on the front end 132 with the new information.

In operation 414, the transaction engine 106 is triggered when a new sale is detected on one or more third-party seller platform servers 204A, 204B, 204C. In operation 416, the transaction engine 106 receive the settlement report via the tracker 206. In operation 418, the transaction engine 106 can determine whether the requested report is available. In operation 420, the transaction engine 106 can parse the settlement report and updates the transactions database 126 with the items that were sold. In operation 422, the transaction engine 106 can validate the statement with respect to the items sold to determine if the transaction is reflected in the settlement. For example, the transaction engine 106 can determine whether the money has been deposited in the first market participant account. In operation 424, the transaction engine 106 can login to the bank using the first market participant credentials to verify the money has been deposited to the bank and can move to operation 426 for manual reconciliation if the money has not been deposited or can move to operation 428 if the money has been deposited. In operation 428, the transaction engine 106 can transfer the money from the bank account of the first market participant to the system 100 escrow account. In operation 430, the transaction engine 106 can transfer money from first market participant to second market participant on the trading platform. In operation 432, the transaction engine 106 can reconcile the unrealized gains and realized gains for the second market participant for the new deal. In operation 434, the transaction engine 106 can execute notes with second market participant and first market participant against the uniform commercial code one.

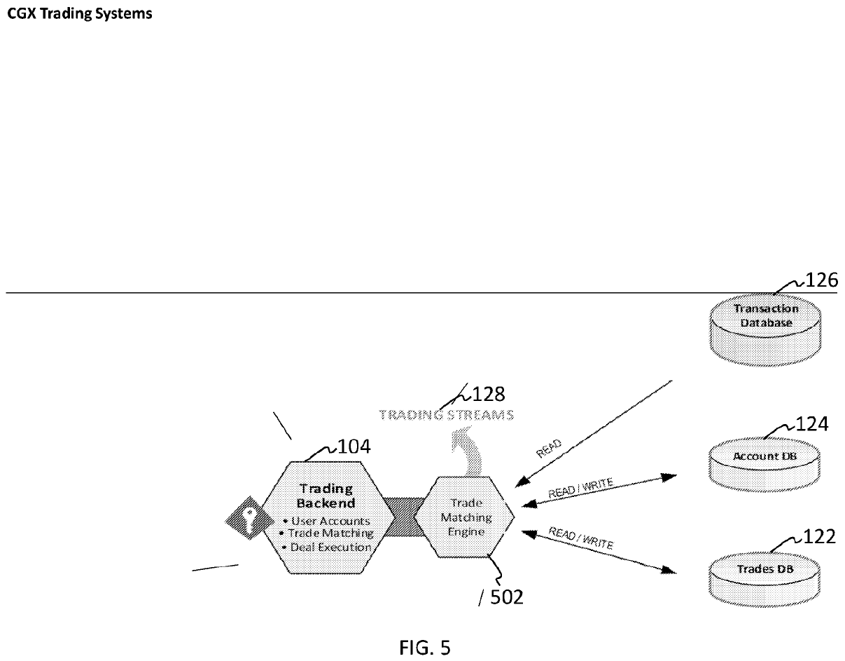

With reference to FIG. 5, an exemplary trading backend 104 for executing real-time low-latency trades based on inventory of products between market participants is illustrated. The trading backend 104 includes a trade matching engine 502 to match and execute trades similar to a financial exchange. The trade matching engine 502 stores each offer and associated bids, along with the specified deal execution rules provided by the first market participant.

The trading backend 104 system emulates a financial exchange, substituting consumer goods for equities, futures, and currencies contracts. The trading backend 104 emulates a financial system where offers are an instrument that is linked to the items available on the inventory list for sale to customers on one or more third-party seller platform servers. For example, the trading backend 104 can process a “single SKU” offer similar to a financial transaction involving shares of Apple (AAPL) and a “Group SKU” offer contains multiple instruments like an ETF.

The trading backend 104 can hold “Bids” for each offer in time-priority order on the backend “offer Book” in the same way the exchange keeps the depth of market for each stock. The trading backend 104 can match the trade when a “bid” & “offer” meet by the “Matching Rules”, the trading backend 104 can execute the deal and generate the corresponding transactions.

In exemplary embodiments, the trading backend 104 can match the trade based on a combination of the product data stream 120 on the emulated exchange and inputs from the first market participant. In exemplary embodiments, the trading backend 104 can impose fundamental checks including rejecting “Bids” if the second market participant does not have funds to cover it, and clearly erroneous “Bids” or “Offers”. The trading backend 104 can support different order types in traditional instrument trading, the matching and trade execution rules for executing is supplied by the first market participant on each “offer” when it is posted to the exchange. The trading backend 104 can implement basic rules like “Auto-Fill-Any”, which executes a deal if the price is hit for any SKU in the offer, or “Auto-Fill-All” which will only execute if the total offer price is met will be available to market participants. The trading backend 104 can in addition to Auto-Fill functionality include functionality for the first market participant to manually accept an offer. To manually accept an offer, the first market participant can interact via the front end 132 to set a minimum threshold at which any “bid” within that range would be instantly brought to the first market participants-entity's attention so the first market participant can make a decision on a case-by-case basis. The trading backend 104 can implement notification options such as in-platform messages, email or text message alerts. The trading backend 104 can implement more advanced “offer types” like auto replenish, which might display a single SKU with low quantity that is automatically re-submitted as the published quantity is sold.

The trading backend 104 can perform risk management checks within the core matching process, and allow real-time validation against any financial or sales metrics that are required. The trading backend 104 also has a rules engine that can be flexible, allowing it to adapt to changing compliance or regulatory rules. The trading backend 104 can send all values within the trade lifecycle that change automatically to the streaming data server 134 which instantly updates the front end 132. These streaming updates from the trading backend 104 include adding and updating of bids and offers, deal executions, and trading account statistics.

The trading backend 104 can generate a trading stream 128 that updates the front end 132 via the trading stream adapter. The trading backend 104 can generate the trading stream 128. The trading stream 128 can in include information such as the “bid”, “offer” and “deal updates.”

In an example, the trading backend 104 can generate an automatic deal when a bid meets the criteria an automatic deal execution is generated or a trade alert is sent to the first market participant, defined by the supplied rules. As described above with reference to FIG. 1, the trading backend 104 can updates the accounts database 124, the trades database 122 or both based on the deals.

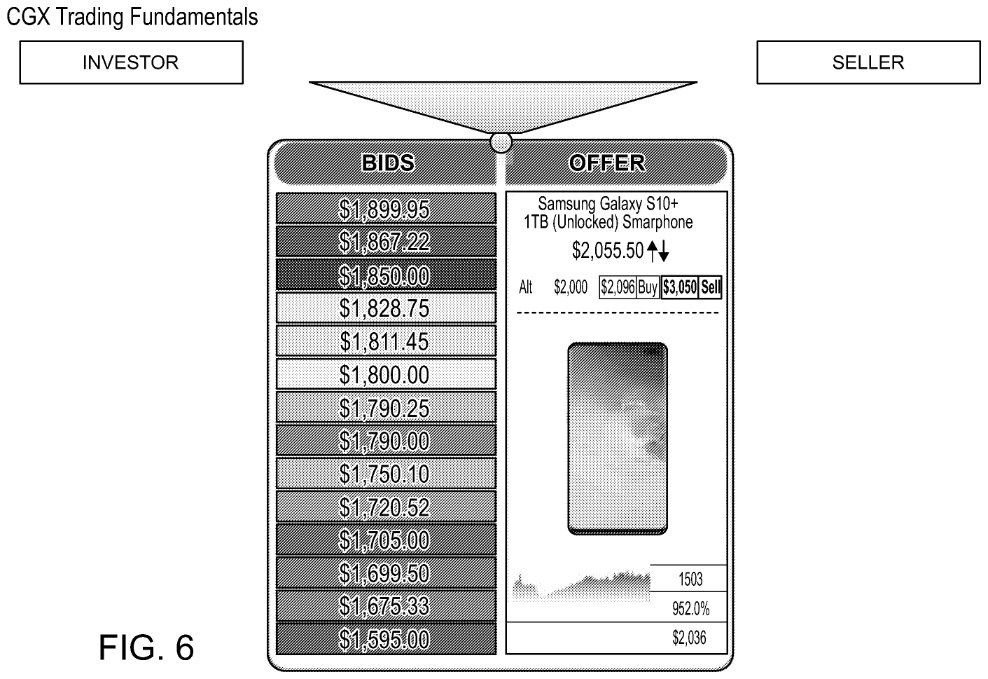

With reference to FIG. 6, the system 100 can generate a front end as illustrated. The system 100 front end can display information about bids, unrealized profits, realized profits, deals, offer, sales, fills and margins calls. For example, the system 100 can provide the following interface for the second market participant to facilitate a deal. In an example, the system 100 can allow the second market participant to communicate via the front end 132 a proposed price for ownership of some or all of the items in an offer. The system 100 can display via the front end 132 hypothetical profit that includes the sum of all sales which have not been paid to the first market participant by the one or more third-party seller platform servers, i.e., unrealized gains. The system 100 can display realized profits from all closed deals.

In an example, the system 100 can display a single or multi-SKU compilation of the first market participants-entity inventory posted or imported into the system 100 at a per-item price. The system 100 can generate a total of the lots and price-each item to derive the total offer price. In an exemplary embodiment, when the first market participant accepts a bid on an offer the system 100 can execute the trade which becomes a deal. The system 100 can remove the offer and bids and an open deal can be displayed on the front end 132 of the second market participant and first market participant accounts.

The system 100 can determine whether a sale associated with the deal has occurred whenever an order for a given product is reported on one or more third-party seller platform servers, and the first market participant has not received the money from the one or more third-party seller platform servers. The system 100 can record the sale once the money has been paid to the first market participant in the form of a Fill, under the associated deal and case use the record to match any returns that might occur in the future.

The system 100 can during each sale of an item in a deal (i.e., a securitized item) on the one or more third-party seller platform servers and subsequently when the first market participant is paid, match the actual sale with a pending sale and generate a Fill transaction. The system 100 can move money from the first market participant to the second market participant (e.g., to a wallet or escrow account of the second market participant). The system 100 can determine when all the products in a deal are Filled, and close the deal.

The system 100 can determine, whenever a fee or refund needs to be done and when the associated first market participant-entities or second market participant-entities wallet does not have enough money a margin call is generated to cover the debit. For example, the system 100 can in response to a determination that the funds are insufficient generate a credit request to address the insufficiency of funds in the account of the first market participant.

The system 100 can handle this in a variety of ways, including notifying support team who can contact the market participant, or an automated procedure involving emailing or text messaging the market participant with instructions to provide the necessary funds to reconcile the transaction.

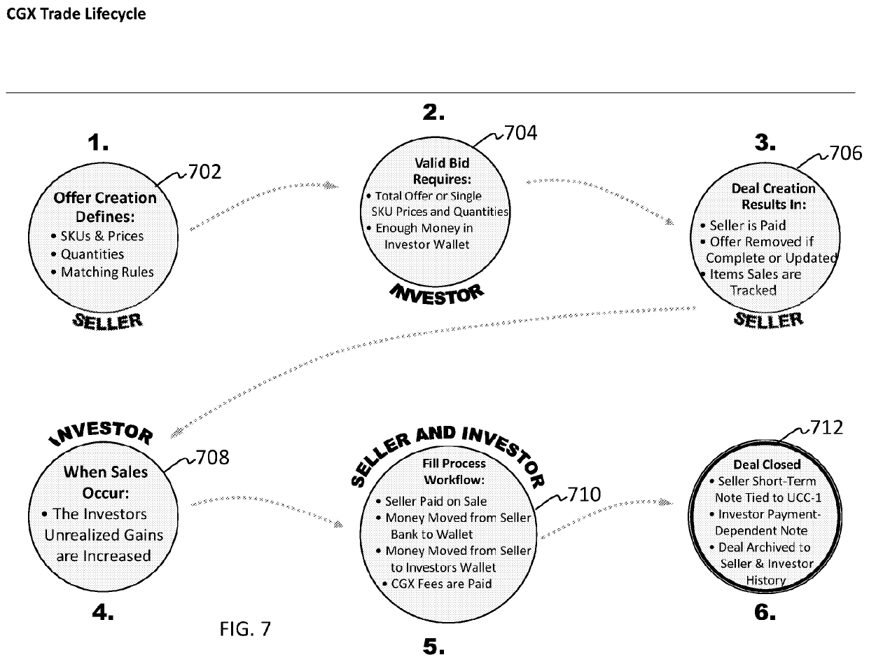

With reference to FIG. 7, the system 100 can implement an exemplary trading lifecycle workflow as illustrated. In an exemplary embodiment, the system 100 can support offer creation, bid process, deal execution, and each leg of the trade. The system 100 can after a deal is closed out determine when the first market participant has been paid on the items and determine that money is posted to the second market participant's wallet, or determine whether the second market participant takes delivery of the actual item instead of waiting for the investment to mature. The system 100 can allow a market participant such as the first market participant to generate an offer that includes information about the SKU or SKUs, price, quantity of the items and the matching rules for the offer. The system 100 can determine whether a bid from a market participant such as the second market participant is valid based on the total offer, single SKU prices and the quantity of the items. The system 100 can determine whether, the deal creation results are available. For example, the system 100 can based on the deal creation check whether the market participant such as the first market participant has been paid, remove the offer if the deal is complete or when the offer is updated, and track the sales of the items on the reseller computing systems that are securitized. The system 100 can determine when sales occurs for a market participant such as second market participant, and update the unrealized gains and the realized gains. The system 100 can determine for a market participant the Fill workflow. For example, the system 100 can determine when a first market participant is paid for a sale on one or more third-party seller platform servers, move money from the bank account of the first market participant to the system 100 escrow account, move money from the first market participant to the second market participant account and the like. The system 100 can determine the fees to be paid for using the system 100. The system 100 can determine that a deal is closed and generate a first market participant short-term note tied to UCC-1, second market participant payment dependent note and archive the deal to the market participant's history.

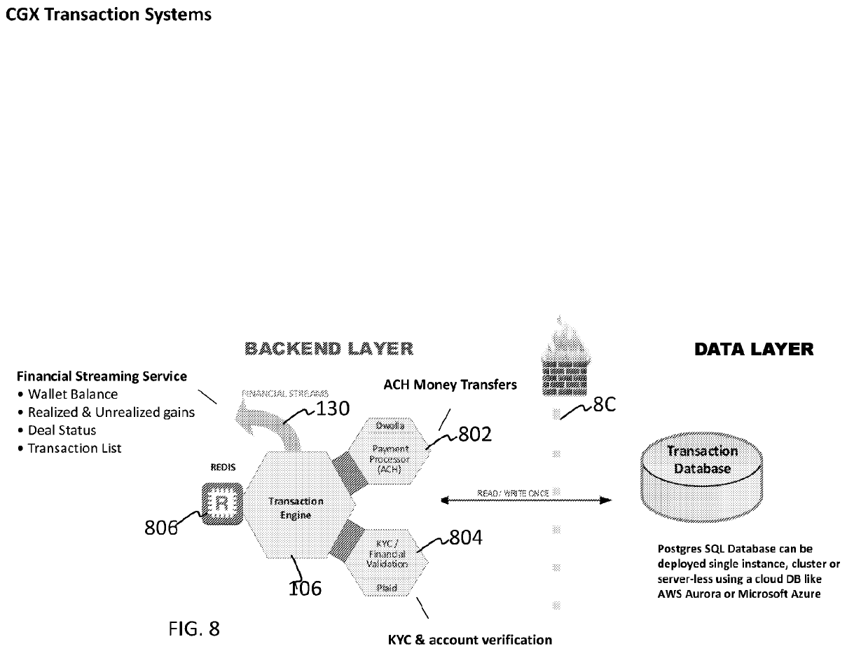

With reference to FIG. 8, an exemplary transaction engine 106 for low-latency transactions is illustrated. The transaction engine 106 can record an audit trail for all monetary transactions within the system 100. The transaction engine 106 can record an audit trail for all account debits and credits including wallet deposits and withdrawals, sales fulfillment and merchandise refunds within a PCI compliant network. The transaction engine 106 can validate customer financial information, bank account links and KYC compliance requirements within this high availability subsystem.

The transaction engine 106 as described above with reference to FIG. 1 generates a financial stream 130 for communication with the banks and other financial entities. The financial stream 130 includes information about the wallet balance, realized and unrealized gains, deal status and transaction list. The transaction engine 106 also has modules for facilitating ACH money transfers and for KYC validation. The transaction engine 106 can also interface with external services for KYC, ACH and integration of credit card and crypto payment processors are connected via a proprietary adapter framework 802, 804 that interfaces the transaction engine 106 to any number of external entities. The transaction engine 106 contains a streaming adapter 806 that pushes updates out the all connected front end clients instantly whenever any values change or are added.

The transaction engine 106 can access the transaction database 126 to record transactions in the data layer 116 with a write once and read-only ledger format.

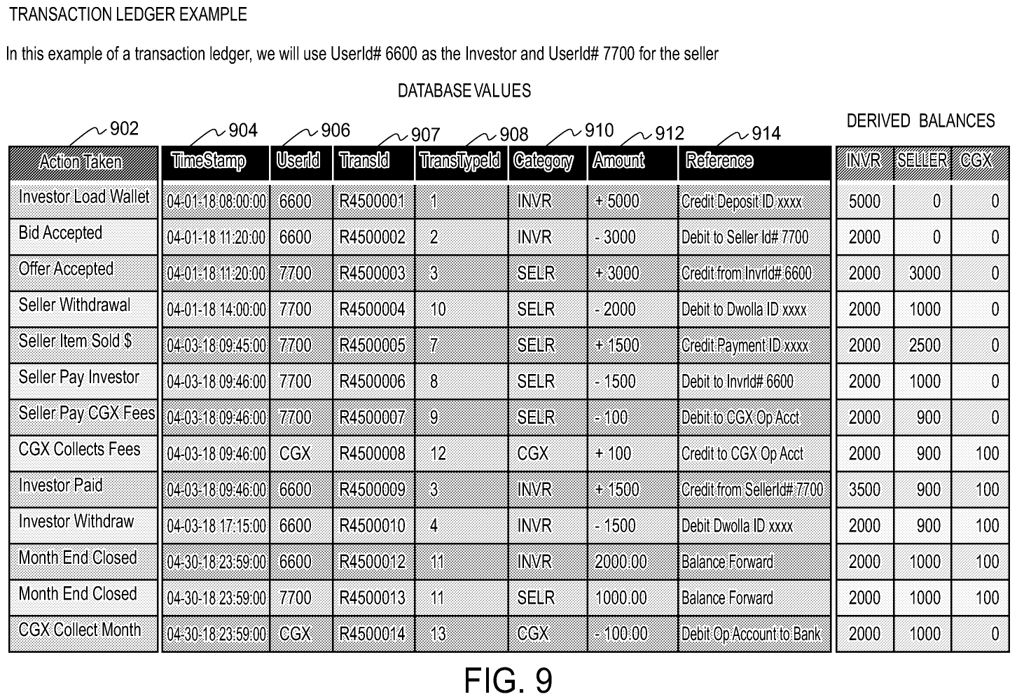

With reference to FIG. 9 an exemplary transaction ledger stored in the data layer 116 is illustrated. The transaction engine 106 can generate the ledger shown in FIG. 9 that includes information about the action taken 902, the timestamp of the action 904, the user id 906 to identify the market participant, the transaction id 907 to identify the transaction, the transaction type 908, the category 910 of the market participant, the amount 912, and the reference number 914 of the payment. The transaction engine 106 can also include information about the derived balances for each of the accounts to provide an audit trail.

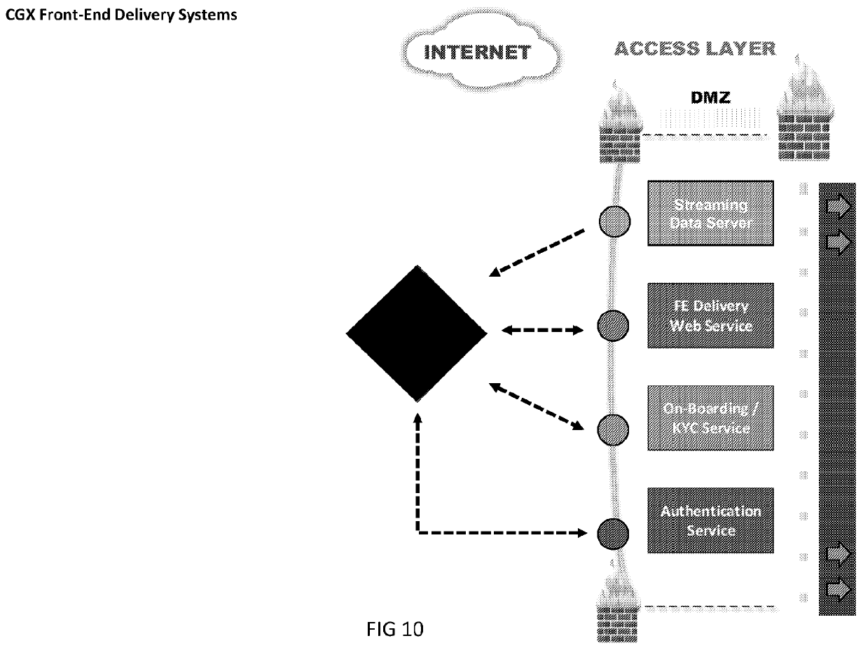

With reference to FIG. 10 an exemplary front end delivery system is illustrated. The system 100 can generate a front end 132 that allows the market participants to interact with the system 100 and exchange data with the system 100. The front end system 132 can provide access to the authentication service 140. The authentication service 140 can utilize a secure token and encryption-key mechanism to verify the identity of the market participant and hide the contents of messages as they traverse the internet. The authentication service 140 can verify signed tokens to protect the integrity of the claims contained within it. The authentication service 140 can hide the claims from other parties using encrypted tokens. The authentication service 140 can sign the tokens using public/private key pairs, to certify that the market participant holding the private key signed it.

The authentication service 140 can provide encrypted tokes for a browser in response to receiving valid credentials. The browser temporarily stores the encrypted tokes in a cookie on the device associated with the market participant. The authentication service 140 facilitates back and forth exchange of this “Validated Ticket” to the system 100 while using each screen to ensure the security of the information and functions of the system 100. This validated token prevents third parties from accessing the functions of the system 100.

The front end 132 allows access to the on-boarding service 138. The on-boarding service 138 can provide user sign-up workflows. The on-boarding service 138 can based on source marketing funnel users based on where they come from. The on-boarding service 138 can collect basic information and initiate additional registration sequences for first market participant account verification, first market participant inventory upload or second market participant deposit transactions. The on-boarding service 138 can notify marketing service to automatically update a database with all applicable information about the users. The front end delivery service 136 can be a web server that sits between the backend layer 114 and the market participants. The front end delivery service 136 can power the front end 132 with non-streaming content and provide request-response services for the front ends 132 to retrieve and display data on-demand. The streaming data server 134 sits between the backend and the market participants to stream data and message notifications to the end-users. In an exemplary embodiment, the streaming message server can use a technology such as LightStreamer software technology to stream data and messages.

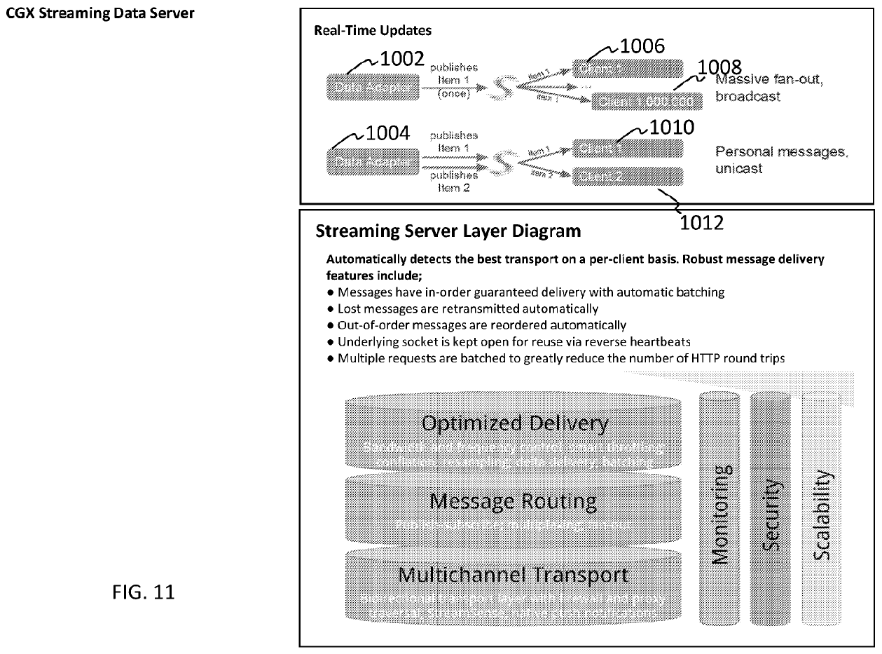

With reference to FIG. 11 the streaming data server 134 to enable high-frequency trading is illustrated. The streaming data server 134 can deliver push data and notification messages to the front end applications to facilitate high-frequency trading system. The streaming data server 134 updates the user applications with sales and trading (bid/offer/deal) information in real-time and provides one to one and one-to-many messaging functionality in the front end 132.

The streaming data server 134 can include a data adapter 1002 configured to publish an item once to many market participants (shown as 1006 1008) in a massive fan-out broadcast. In exemplary embodiments, the streaming data server 134 can include a data adapter 1004 configured to publish personal messages relating to an items to a market participant (shown as 1010 1012).

The streaming data server 134 can detect the best transport mechanism for each market participant. The streaming data server 134 can deliver messages in-order guaranteed delivery with automatic batching, retransmit lost messages automatically, reorder out-of-order messages automatically, keep the underlying socket open for reuse via reverse heartbeats and batch process multiple requests to greatly reduce the number of HTTP round trips.

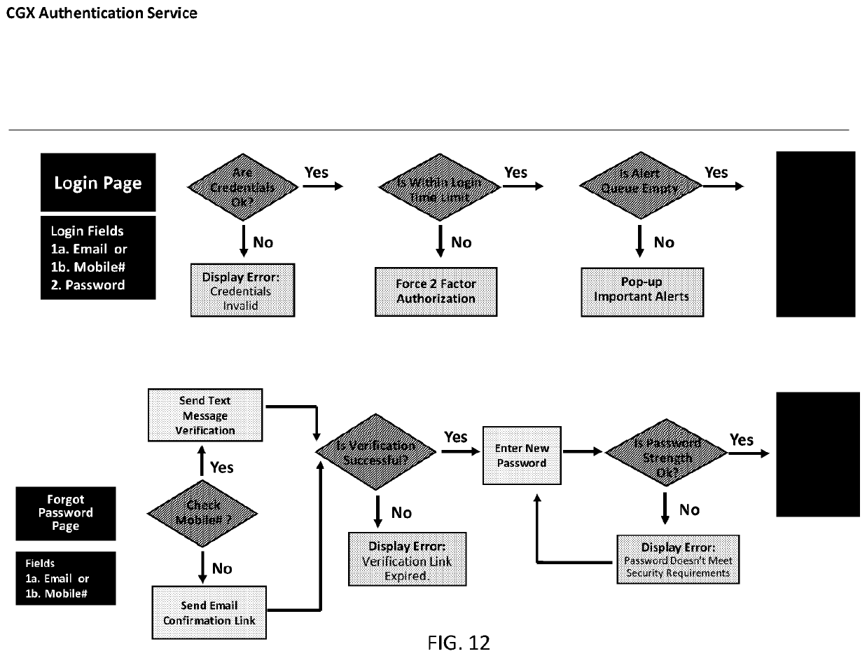

With reference to FIG. 12 the authentication service 140 is illustrated. The authentication service 140 can use the Registration API to processes new market participants from various marketing funnels the new market participants used for sign-up. The authentication service 140 can accept simple HTTP POST commands that provide front end components to display registration screens. The authentication service 140 can include a default set of registration screens that is built-in to front end that collects the basic profile information common to market participants such as second market participants and first market participants.

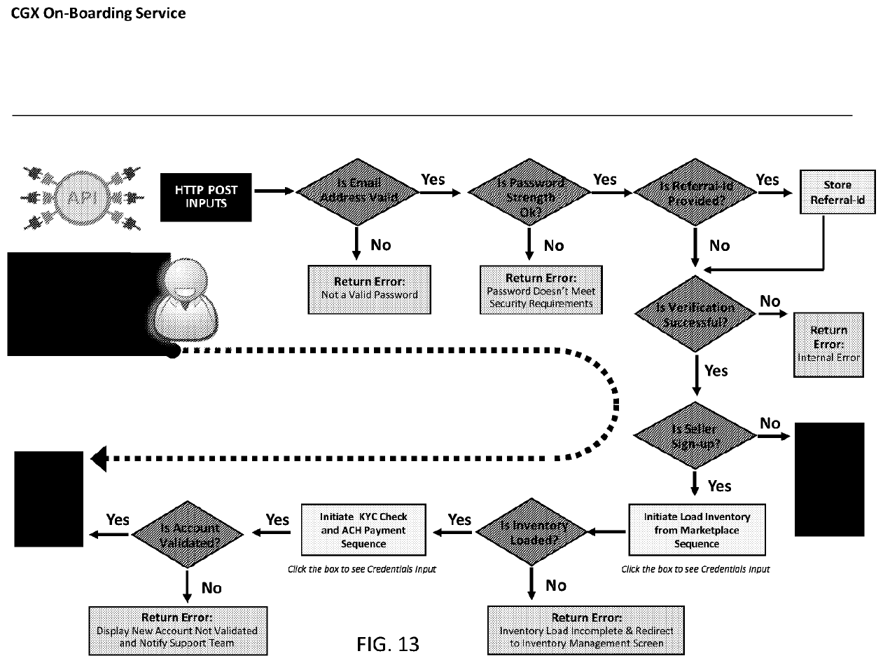

With reference to FIG. 13 the on-boarding service 138 according is illustrated. The on-boarding service 138 can use the Registration API to processes market participants from various marketing funnels they used for sign-up. The on-boarding service 138 accepts simple HTTP POST commands that provide front end components to display registration screens. The on-boarding service 138 can include a default set of registration screens that is built-in to front end that collects the basic profile information common to market participants such as second market participants and first market participants.

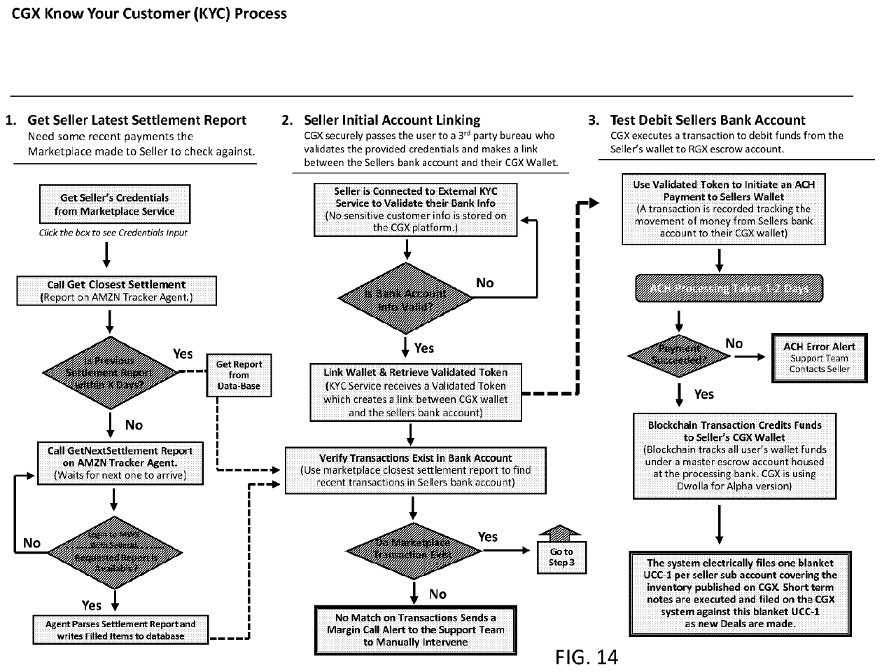

With reference to FIG. 14 the system 100 can execute the workflows to process the KYC process for market participants. The system 100 can use the illustrated steps to validate a new wallet of the first market participant and to linked the wallet to their bank account used for making payments for products sold by the first market participant. The system 100 can transfer the money from the first market participant to the wallet of the second market participant when product sales are Filled. The system 100 can also perform this KYC validation from the market participant profile, in addition to the on-boarding sequence when a new first market participant signs-up. The system 100 can also periodically perform this check automatically. In an exemplary embodiment, the system 100 can use a bank interconnect service such as PLAID.

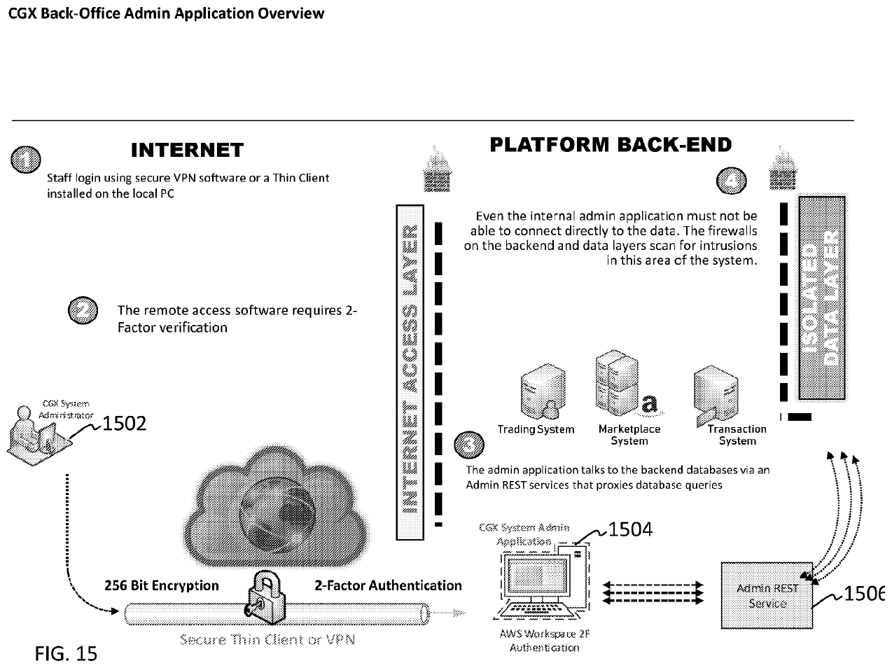

With reference to FIG. 15 a back-office admin application for system 100 is illustrated. For example, the system 100 can allow an administrator 1502 access to the backend layer 114 through a secure thin client that is different from the front end 132. The system 100 can allow the administrator 1502 accessible via a secure VPN or thin client. In an exemplary embodiment, the system 100 can utilize a 256-bit encryption and 2-factor authentication to secure the system 100 and ensure only the administrator 1502 can access the system 100. In an exemplary embodiment, the back-office admin application can execute on a desktop with Java and JFX Front End framework. The back-office admin application can include products, users and account management, ledger viewer, manual transactions and system settings screens.

The back-office admin application can limit access to only the administrator 1502 using secure VPN software or a thin client installed on the local PC. The system 100 can use VPN to allow a connection to the internal back-office admin server from the browser of the administrator 152 on the backend server 1504 in the backend layer 114. The use of a thin client allows the administrator to use a device on the cloud to access the backend layer 114 through remote software, that emulates the look and feel of a local PC. The system 100 can use 2-Factor authentication to verify the credentials of the administrator 1502 before allowing access. The system 100 can allow the back-office admin application to communicate with the backend databases in the data layer 116 via the admin rest service 1506. The admin rest service 1506 proxies the database queries and returns information to the back end admin application. In an exemplary embodiment, the admin rest service 1506 can return information in a JSON format.

In an exemplary embodiment, the system 100 can prevent the internal admin application from directly connecting to the data. The system 100 can include the data layer firewall 108c that scans for intrusions from the backend layer 114 to the data layer 116. The system 100 can disable access to the data in the data layer 116 from unknown software on any port or internet protocol address within the various layers. The system 100 can disable and block further requests as soon as an intrusion is detected that tries to access the data layer 116.

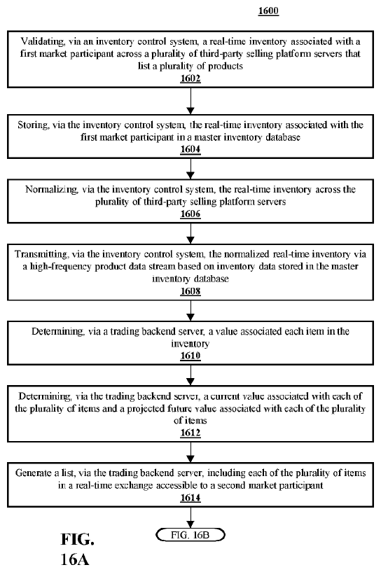

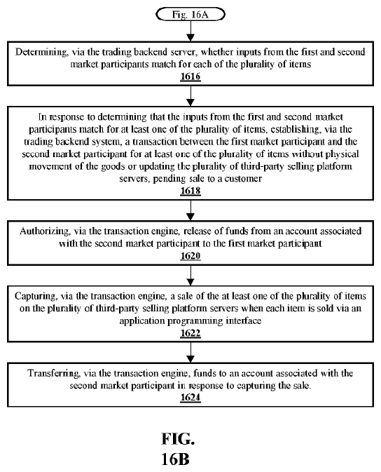

With reference to FIGS. 16A and 16B, an exemplary flow chart of method to secure and generate real-time high-frequency product data streams to facilitate low-threshold transactions is illustrated. The operations 1602-1624 describe a method of generating the product data stream 120 to facilitate high-frequency transactions. In operation 1602, the inventory service system 102 can validate a real-time inventory associated with a first market participant across a plurality of third-party selling platform servers that list a plurality of products. In operation 1604, the inventory service system 102 can store the real-time inventory data associated with the first market participant in a master inventory database secured behind a data layer firewall 108c. In operation 1606, the inventory service system 102 can, normalize the real-time inventory across the plurality of third-party selling platform servers. In operation 1608, the inventory service system 102 can transmit the normalized real-time inventory via a high-frequency product data stream 120 based on inventory data stored in the master inventory database. In operation 1610, the inventory service system 102 can determine a value associated each item in the inventory. In operation 1612, the trading backend 104 a current value associated with each of the plurality of items and a projected future value associated with each of the plurality of items. In operation 1614, the trading backend 104 can generate a list including each of the plurality of items in a real-time exchange accessible to a second market participant. In operation 1616, the trading backend 104 determine whether inputs from the first and second market participants match for each of the plurality of items. In operation 1618, the trading backend 104 in response to determining that the inputs from the first and second market participants match for at least one of the plurality of items can establish a transaction between the first market participant and the second market participant for at least one of the plurality of items without physical movement of the goods or updating the plurality of third-party selling platform servers, pending sale to a customer. In operation 1620, the transaction engine 106 can authorize release of funds from an account associated with the second market participant to the first market participant. In operation 1622, the transaction engine 106 can capture a sale of the at least one of the plurality of items on the plurality of third-party selling platform servers when each item is sold via an application programming interface. In operation 1624, the transaction engine 106 can funds to an account associated with the second market participant in response to capturing the sale.

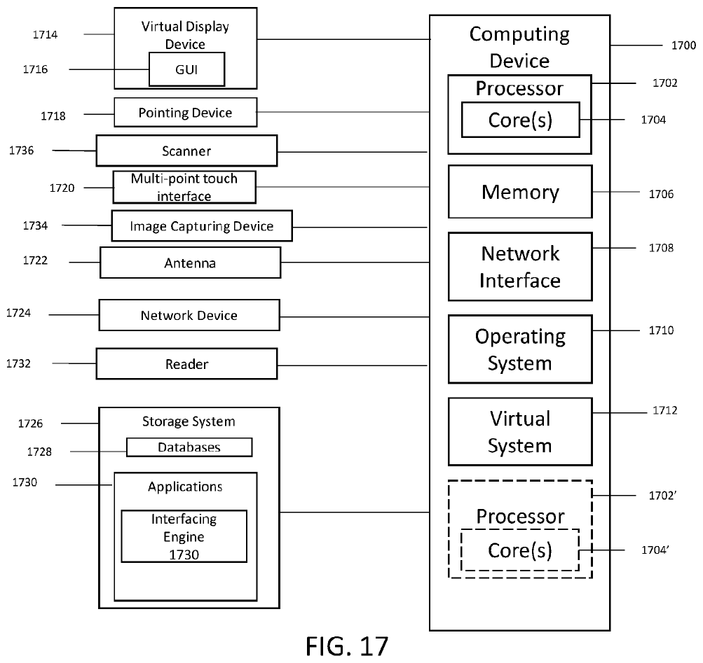

With reference to FIG. 17, a block diagram of an example computing device for implementing exemplary embodiments of the present disclosure is illustrated. An exemplary embodiment of whole slide imaging system can be implemented by the computing device. The computing device 1700 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 1706 included in the computing device 1700 may store computer-readable and computer-executable instructions or software (e.g., applications 1730) for implementing exemplary operations of the computing device 1700. The computing device 1700 also includes configurable and/or programmable processor 1702 and associated core(s) 1704 and, optionally, one or more additional configurable and/or programmable processor(s) 1702′ and associated core(s) 1704′ (for example, in the case of computer systems having multiple processors/cores), for executing computer-readable and computer-executable instructions or software stored in the memory 1706 and other programs for implementing exemplary embodiments of the present disclosure. Processor 1702 and processor(s) 1702′ may each be a single core processor or multiple core (1704 and 1704′) processor. Either or both of processor 1702 and processor(s) 1702′ may be configured to execute one or more of the instructions described in connection with computing device 1700.

Virtualization may be employed in the computing device 1700 so that infrastructure and resources in the computing device 1700 may be shared dynamically. A virtual machine 1712 may be provided to handle a process running on multiple processors so that the process appears to be using only one computing resource rather than multiple computing resources. Multiple virtual machines may also be used with one processor.

Memory 1706 may include a computer system memory or random access memory, such as DRAM, SRAM, EDO RAM, and the like. Memory 1706 may include other types of memory as well, or combinations thereof. A user may interact with the computing device 1700 through a visual display device 1714, such as a computer monitor, which may display one or more graphical user interfaces 1716, multi-touch interface 1720, and a pointing device 1718. The computing device 1700 may also include one or more storage devices 1726, such as a hard-drive, CD-ROM, or other computer-readable media, for storing data and computer-readable instructions and/or software that implement exemplary embodiments of the present disclosure (e.g., applications). For example, exemplary storage device 1726 can include one or more databases 1728 for storing information regarding the physical objects. The databases 1728 may be updated manually or automatically at any suitable time to add, delete, and/or update one or more data items in the databases.

The computing device 1700 can include a network interface 1708 configured to interface via one or more network devices 1724 with one or more networks, for example, Local Area Network (LAN), Wide Area Network (WAN) or the internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 1722 to facilitate wireless communication (e.g., via the network interface) between the computing device 1700 and a network and/or between the computing device 800 and other computing devices. The network interface 1708 may include a built-in network adapter, network interface card, PCMCIA network card, card bus network adapter, wireless network adapter, USB network adapter, modem or any other device suitable for interfacing the computing device 1700 to any type of network capable of communication and performing the operations described herein.

The computing device 1700 may run any operating system 1710, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device 1700 and performing the operations described herein. In exemplary embodiments, the operating system 1710 may be run in native mode or emulated mode. In an exemplary embodiment, the operating system 1710 may be run on one or more cloud machine instances.

An exemplary flowchart is provided herein for illustrative purposes and is a non-limiting example of a method. One of ordinary skill in the art will recognize that exemplary methods may include more or fewer steps than those illustrated in the exemplary flowcharts.

1. A system for securing and generating real-time high-frequency product data streams to facilitate low-latency transactions, the system comprising:
at least one processor operatively connected to a memory containing instructions, that when executed cause the at least one processor to:
validate a real-time inventory associated with a first market participant across a plurality of third-party selling platform servers that list a plurality of products using an inventory service system;
store the real-time inventory associated with the first market participant in a master inventory database;
normalize the real-time inventory across the plurality of third-party selling platform servers using the inventory service system;
transmit the normalized real-time inventory via a high-frequency product data stream based on inventory data stored in the master inventory database;
determine a value associated each item in the inventory using a trading backend;
determine a current value associated with each of the plurality of items and a projected future value associated with each of the plurality of items using the trading backend;
generate a list including each of the plurality of items in a real-time exchange accessible to a second market participant using the trading backend;
determine whether inputs from the first and second market participants match for each of the plurality of items;
in response to determining that the inputs from the first and second market participants match for at least one of the plurality of items, establish a transaction between the first market participant and the second market participant for at least one of the plurality of items without physical movement of the items or updating the plurality of third-party selling platform servers, pending sale to a customer;
authorize release of funds from an account associated with the second market participant to the first market participant;
capture a sale of the at least one of the plurality of items on the plurality of third-party selling platform servers when each item is sold via an application programming interface; and
transfer funds to an account associated with the second market participant in response to capturing the sale.

2. The system in claim 1, wherein the at least one processor is configured to:
poll the plurality of third-party selling platform servers at a polling rate less than a throttling threshold using the inventory service system;
parse a sales report received from the plurality of third-party selling platform servers to determine a change in the inventory data associated with the first market participant, sale of items in the inventory or both using the inventory service system; and
generate the high-frequency product data stream based on inventory data stored in the master inventory database and the parsed sales report.

3. The system in claim 1, wherein the processor is configured to:
package multiple items into an item listing before creating a list including each of the plurality of items.

4. The system in claim 1, wherein the at least one processor is configured to:
receive offers from the first market participant to list each item using the trading backend.

5. The system in claim 1, wherein the at least one processor is configured to:
receive offers to modify each listed item using the trading backend.

6. The system in claim 1, wherein the at least one processor is configured to:
track an account on the plurality of third-party selling platform servers that is associated with the first market participant to determine when the at least one of the plurality of items is sold using a transaction engine;
poll the plurality of third-party selling platform servers to receive sales data using the transaction engine;
validate the sale of the at least one of the plurality of items based on a sales report received from the plurality of third-party selling platform servers using the transaction engine;
transfer funds from an account associated with the first market participant to an escrow account using the transaction engine; and
transfer funds from the escrow account to the account associated with the second market participant using the transaction engine.

7. The system in claim 1, wherein the at least one processor is configured to:
validate the eligibility of the second market participant based on an availability of funds before allowing the second market participant to use the trading backend.

8. The system in claim 1, wherein the at least one processor is configured to
determine a return of an item for refund on at least one of the plurality of third-party selling platform servers;
determine whether the funds in the account of the first market participant are insufficient to cover the refund; and
in response to a determination that the funds are insufficient generate a credit request to address the insufficiency of funds in the account of the first market participant.

9. The system in claim 1, wherein the at least one processor is configured to:
determine a return of an item on at least one of the plurality of third-party selling platform servers, using a transaction engine; and
adjust the real-time listing of products to reflect a change in inventory of the item using the transaction engine.

10. The system in claim 1, wherein the at least one processor is configured to:
store an immutable ledger of the transactions after matching the inputs of the first and second market participants related to the at least one of the plurality of items.

11. A method to secure and generate real-time high-frequency product data streams to facilitate low-threshold transactions, the method comprising:
validating, via an inventory service system, a real-time inventory associated with a first market participant across a plurality of third-party selling platform servers that list a plurality of products;
storing, via the inventory service system, the real-time inventory associated with the first market participant in a master inventory database;
normalizing, via the inventory service system, the real-time inventory across the plurality of third-party selling platform servers;
transmitting, via the inventory service system, the normalized real-time inventory via a high-frequency product data stream based on inventory data stored in the master inventory database;
determining, via a trading backend, a value associated each item in the inventory;
determining, via the trading backend, a current value associated with each of the plurality of items and a projected future value associated with each of the plurality of items;
generating a list, via the trading backend, including each of the plurality of items in a real-time exchange accessible to a second market participant;
determining, via the trading backend, whether inputs from the first and second market participants match for each of the plurality of items;
in response to determining that the inputs from the first and second market participants match for at least one of the plurality of items, establishing, via the trading backend, a transaction between the first market participant and the second market participant for at least one of the plurality of items without physical movement of the items or updating the plurality of third-party selling platform servers, pending sale to a customer;
authorizing, via a transaction engine, release of funds from an account associated with the second market participant to the first market participant;
capturing, via the transaction engine, a sale of the at least one of the plurality of items on the plurality of third-party selling platform servers when each item is sold via an application programming interface; and
transferring, via the transaction engine, funds to an account associated with the second market participant in response to capturing the sale.

12. The method in claim 11, further comprising:
polling, via the inventory service system, the plurality of third-party selling platform servers at a polling rate less than a throttling threshold;
parsing, via the inventory service system, a sales report received from the plurality of third-party selling platform servers to determine a change in the inventory data associated with the first market participant, sale of items in the inventory or both; and
generating, via the inventory service system, the high-frequency product data stream based on inventory data stored in the master inventory database and the parsed sales report.

13. The method in claim 11, further comprising:
packaging, via the trading backend, multiple items into an item listing before creating a list including each of the plurality of items.

14. The method in claim 11, further comprising:
receiving, via the trading backend, offers from the first market participant to list each item.

15. The method in claim 11, further comprising:
receiving, via the trading backend, offers to modify each listed item.

16. The method in claim 11, further comprising:
tracking, via the transaction engine, an account on the plurality of third-party selling platform servers that is associated with the first market participant to determine when the at least one of the plurality of items is sold;
polling, via the transaction engine, the plurality of third-party selling platform servers to receive sales data;
validating, via the transaction engine, the sale of the at least one of the plurality of items based on a sales report received from the plurality of third-party selling platform servers;
transferring, via the transaction engine, funds from an account associated with the first market participant to an escrow account; and
transferring, via the transaction engine, funds from the escrow account to the account associated with the second market participant.

17. The method in claim 11, further comprising:
validating, via the trading backend, the eligibility of the second market participant based on an availability of funds before allowing the second market participant to use the trading backend.

18. The method in claim 11, further comprising:
determining, via the transaction engine, a return of an item for refund on at least one of the plurality of third-party selling platform servers;
determining, via the transaction engine, whether the funds in the account of the first market participant are insufficient to cover the refund; and
in response to a determination that the funds are generating, via the transaction engine, a credit request to address the insufficiency of funds in the account of the first market participant.

19. The method in claim 11, further comprising:
determining, via the transaction engine, a return of an item on at least one of the plurality of third-party selling platform servers; and
adjusting, via the transaction engine, the real-time listing of products to reflect a change in inventory of the item.

20. The method in claim 11, further comprising:
storing, via the transaction engine, an immutable ledger of the transactions after matching the inputs of the first and second market participants related to the at least one of the plurality of items.
